(19) United States
(12) Patent Application Publication
(10) Pub. No.: US 2025/0137968 A1
(43) Pub. Date: May 1, 2025

(54) ULTRASONIC INSPECTION APPARATUS AND ULTRASONIC INSPECTION METHOD

(71) Applicant: HITACHI POWER SOLUTIONS CO., LTD., Hitachi-shi, Ibaraki (JP)

(72) Inventors: Mutsumi SUZUKI, Tokyo (JP); Yuusuke KOURAI, Tokyo (JP); Shigeru OHNO, Ibaraki (JP)

(21) Appl. No.: 18/694,651

(22) PCT Filed: Jul. 13, 2022
(86) PCT No.: PCT/JP2022/027599

§ 371 Date: Mar. 22, 2024

(30) Foreign Application Priority Data
Oct. 4, 2021 (JP) 2021-163615

(51) Int. Cl. G01N 29/04; G01N 29/28

(52) U.S. Cl. CPC G01N 29/04; G01N 29/28; G01N 2291/023; G01N 2291/0289; G01N 2291/102

(57) ABSTRACT

Provided is an ultrasonic inspection apparatus that offers high capability to detect a defect part that allow detection of a minute defect of a small detectable size. The ultrasonic inspection apparatus includes a scanning/measuring device that carries out scanning and measurement on an inspection subject, using an ultrasonic beam, and a control device that controls driving of the scanning/measuring device. The scanning/measuring device includes a transmission probe that emits the ultrasonic beam, and a reception probe that receives the ultrasonic beam. The control device includes a signal processing unit. The signal processing unit includes a filter unit reducing at least a maximum intensity frequency component of a reception signal received by the reception probe. The filter unit detects a skirt component in a fundamental waveband including the maximum intensity frequency component, the skirt component being a part of the fundamental waveband that is other than the maximum intensity frequency component.

### TECHNICAL FIELD

The present disclosure relates to an ultrasonic inspection apparatus and an ultrasonic inspection method.

### BACKGROUND ART

A method of inspecting a defect part of an inspection subject, the method using an ultrasonic beam, is known. For example, when a defect part (cavity or the like) with a small acoustic impedance like air is present inside the inspection subject, an acoustic impedance gap develops inside the inspection subject. This reduces an amount of transmission of the ultrasonic beam. By measuring the amount of transmission of the ultrasonic beam, therefore, the defect part inside the inspection subject can be detected.

A technique described in PTL 1 is known as a technique related to an ultrasonic inspection apparatus. According to the ultrasonic inspection apparatus described in PTL 1, a rectangular wave burst signal, which is composed of a series of a given number of negative rectangular waves, is applied to a transmission ultrasonic probe disposed counter to a reception ultrasonic probe across an inspection subject via air. The reception ultrasonic probe disposed counter to the transmission ultrasonic probe across the inspection subject via air converts an ultrasonic wave having traveled through the inspection subject into a transmitted wave signal. Based on the signal level of the transmitted wave signal, whether the inspection subject has a defect is determined. In the transmission ultrasonic probe and the reception ultrasonic probe, the acoustic impedance of a transducer and that of a front plate attached to the ultrasonic wave transmission/reception side of the transducer are each set lower than the acoustic impedance of a contact ultrasonic probe used in a state of being in contact with the inspection subject.

### CITATION LIST

### Patent Literature

PTL 1: JP 2008-128965 A

### SUMMARY OF INVENTION

### Technical Problem

The ultrasonic inspection apparatus described in PTL 1 has a problem that it has difficulty in detecting a minute defect in the inspection subject. In particular, when the size of a defect to be detected is smaller than that of the ultrasonic beam, detecting the defect becomes difficult.

In order to solve the above problem, the present disclosure provides an ultrasonic inspection apparatus and an ultrasonic inspection method that offer a high capability to detect a defect part, for example, that allow detection of a minute defect of a small detectable size.

### Solution to Problem

An ultrasonic inspection apparatus according to the present disclosure is an ultrasonic inspection apparatus that inspects an inspection subject by emitting an ultrasonic beam onto the inspection subject via a fluid. The ultrasonic inspection apparatus includes a scanning/measuring device that carries out scanning and measurement on the inspection subject, using the ultrasonic beam, and a control device that controls driving of the scanning/measuring device. The scanning/measuring device includes a transmission probe that emits the ultrasonic beam, and a reception probe that receives the ultrasonic beam. The control device includes a signal processing unit. The signal processing unit includes a filter unit that reduces at least a maximum intensity frequency component of a reception signal received by the reception probe. The filter unit detects a skirt component in a fundamental waveband including the maximum intensity frequency component, the skirt component being a part of the fundamental waveband that is other than the maximum intensity frequency component. Other solutions will be described later in embodiments for carrying out the invention.

### Advantageous Effects of Invention

According to the present disclosure, an ultrasonic inspection apparatus and an ultrasonic inspection method that offer a high capability to detect a defect part, for example, that allow detection of a minute defect of a small detectable size can be provided.

### BRIEF DESCRIPTION OF DRAWINGS

FIG. 1 depicts a configuration of an ultrasonic inspection apparatus according to a first embodiment.

FIG. 2 is a schematic cross-sectional view of the structure of a transmission probe.

FIG. 3A depicts a propagation path of an ultrasonic beam according to a conventional ultrasonic inspection method, showing a case where the ultrasonic beam is incident on a sound part.

FIG. 3B depicts the propagation path of the ultrasonic beam according to the conventional ultrasonic inspection method, showing a case where the ultrasonic beam is incident on a defect part.

FIG. 4 depicts an interaction between the defect part and the ultrasonic beam in an inspection subject, showing a state where a directly reaching ultrasonic beam is received.

FIG. 5 is a schematic view of a scattered wave that is the ultrasonic beam having interacted with the defect part

FIG. 6 is a functional block diagram of a control device.

FIG. 7 is a schematic view of distribution of frequency components (frequency spectrum) of a reception signal.

FIG. 8A depicts a position-dependent change in signal intensity information that results when a transmission probe and a reception probe scan across the defect part.

FIG. 8B depicts a result of measurement of signal intensity by the control device including a filter unit.

FIG. 9 depicts the voltage waveform of a burst wave applied to the transmission probe.

FIG. 10 depicts a frequency component distribution of a reception signal under conditions indicated in FIG. 9.

FIG. 11 is a graph in which measurement data of a frequency component distribution (frequency spectrum) of a reception signal, the measurement data being data on the sound part, and measurement data of a frequency component distribution (frequency spectrum) of a reception signal, the measurement data being data on the defect part, are compared with each other.

FIG. 12A depicts frequency characteristics of a gain of a band elimination filter.

FIG. 12B is a schematic view of frequency characteristics of a signal having been processed by the band elimination filter.

FIG. 13A depicts frequency characteristics of a gain of a low-pass filter.

FIG. 13B is a schematic view of frequency characteristics of a signal having been processed by the low-pass filter.

FIG. 14A depicts frequency characteristics of a gain of a high-pass filter.

FIG. 14B is a schematic view of frequency characteristics of a signal having been processed by the high-pass filter.

FIG. 15 is a block diagram of the filter unit of a digital type.

FIG. 16 is a block diagram of a filter unit according to a different embodiment.

FIG. 17A is a schematic view of a propagation path of the ultrasonic beam in a case where the focal distance of the transmission probe is set equal to the focal distance of the reception probe.

FIG. 17B is a schematic view of a propagation path of the ultrasonic beam in a case where the focal distance of the reception probe is set longer than the focal distance of the transmission probe.

FIG. 18 is a diagram for explaining a relationship between a beam incident area of the transmission probe and a beam incident area of the reception probe.

FIG. 19 depicts a configuration of an ultrasonic inspection apparatus according to a second embodiment.

FIG. 20A is a diagram for explaining a transmission sound axis, a reception sound axis, and an eccentric distance, showing a case where the transmission sound axis and the reception sound axis extend in a vertical direction.

FIG. 20B is a diagram for explaining the transmission sound axis, the reception sound axis, and the eccentric distance, showing a case where the transmission sound axis and the reception sound axis extend slantly.

FIG. 21 depicts a configuration of an ultrasonic inspection apparatus according to a third embodiment.

FIG. 22 is a diagram for explaining the reason why the effects of the third embodiment are produced.

FIG. 23 depicts a configuration of an ultrasonic inspection apparatus according to a fourth embodiment.

FIG. 24 is a functional block diagram of a control device in an ultrasonic inspection apparatus according to a fifth embodiment.

FIG. 25 is a functional block diagram of the control device in an ultrasonic inspection apparatus according to a sixth embodiment.

FIG. 26 depicts a hardware configuration of the control device.

FIG. 27 is a flowchart showing an ultrasonic inspection method of each of the above embodiments.

### DESCRIPTION OF EMBODIMENTS

Hereinafter, modes for carrying out the present disclosure (which are referred to as embodiments) will be described with reference to the drawings. It should be noted, however, that the present disclosure is not limited to the following embodiments and that, for example, different embodiments may be combined or any modification may be made on condition that such modification does not significantly impair the effects of the present disclosure. The same members are denoted by the same reference signs, and redundant description will be omitted. Furthermore, constituent elements having the same function are given the same name. What is illustrated is schematic one, and, for convenience in illustration, may differ from an actual configuration to an extent that the difference does not significantly impair the effects of the present disclosure.

### First Embodiment

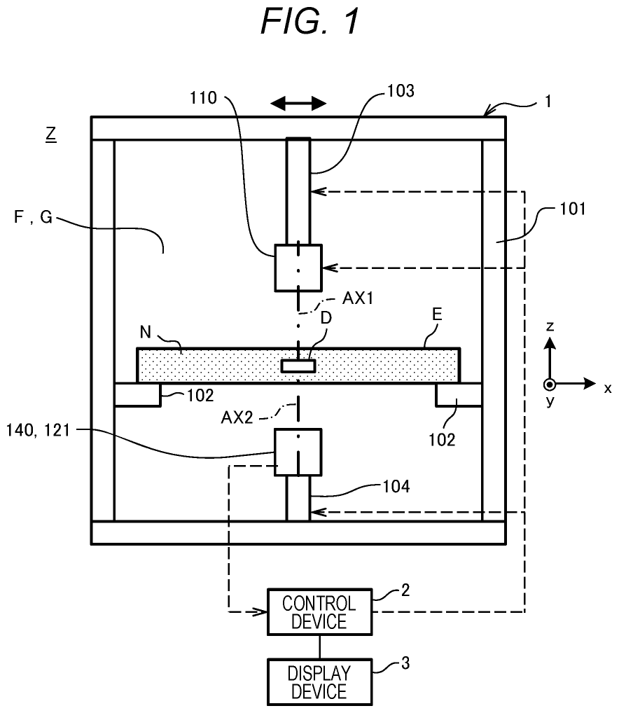

FIG. 1 depicts a configuration of an ultrasonic inspection apparatus Z according to a first embodiment. In FIG. 1, a schematic cross-sectional view of a scanning/measuring device 1 is shown. FIG. 1 shows an orthogonal three axes coordinate system including an x-axis extending in a horizontal direction along the paper surface, a y-axis extending in a direction perpendicular to the paper surface, and a z-axis extending in a vertical direction along the paper surface.

The ultrasonic inspection apparatus Z inspects an inspection subject E by emitting an ultrasonic beam U (which will be described later) onto the inspection subject E via a fluid F. The fluid F is, for example, a liquid W (which will be described later), such as water, or a gas G, such as air, and the inspection subject E is present in the fluid F. In the first embodiment, air (an example of the gas G) is used as the fluid F. The inside of an enclosure 101 of the scanning/measuring device 1 is, therefore, a cavity filled with air. As shown in FIG. 1, the ultrasonic inspection apparatus Z includes the scanning/measuring device 1, a control device 2, and a display device 3. The display device 3 is connected to the control device 2.

The scanning/measuring device 1 carries out scanning and measurement on the inspection subject E, using the ultrasonic beam U, and includes a sample stage 102 fixed to the enclosure 101. The inspection subject E is placed on the sample stage 102. The inspection subject E is made of any given material. The inspection subject E is, for example, a solid material. More specifically, for example, it is a metal, glass, a resin material, or a composite material like carbon fiber reinforced plastic (CFRP). In the example of FIG. 1, the inspection subject E has a defect part D therein. The defect part D is a cavity or the like. Examples of the defect part D include a cavity and a foreign material different from an intended material. The other part of inspection subject E that is different from the defect part D is referred to as a sound part N.

Because the defect part D and the sound part N are made of different materials, respectively, an acoustic impedance in the defect part D and the same in the sound part N are different from each other, which results in a change in the propagation characteristics of the ultrasonic beam U. The ultrasonic inspection apparatus Z observes this change in the propagation characteristics, thus detecting the defect part D.

The scanning/measuring device 1 includes a transmission probe 110 that emits the ultrasonic beam U, and a reception probe 121. The transmission probe 110 is disposed on the enclosure 101 via a transmission probe scanning unit 103, and emits the ultrasonic beam U. The reception probe 121 is a reception probe 140 (coaxially set reception probe) that is disposed opposite to the transmission probe 110 with respect to the inspection subject E, that receives the ultrasonic beam U, and that is set coaxial with the transmission probe 110 (an eccentric distance L, which will be described later, is 0). In the first embodiment, therefore, the eccentric distance L (distance) between the transmission sound axis AX1 (sound axis) of the transmission probe 110 and the reception sound axis AX2 (sound axis) of the reception probe 140 is 0. As a result, the transmission probe 110 and the reception probe 140 can be disposed easily.

“opposite to the transmission probe 110” means “a space opposite to a space in which the transmission probe 110 is located (the opposite side in the z direction), the space being one of two spaces separated by the inspection subject E”, and does not means a position defined by the same x and y coordinates on the opposite side (that is, a position plane symmetry with respect to the xy plane).

A positional relationship between the transmission probe 110 and the reception probe 121 will be described. The distance between the transmission sound axis AX1 of the transmission probe 110 and the reception sound axis AX2 of the reception probe 121 is defined as the eccentric distance L. In the first embodiment, the eccentric distance L is set to zero as described above. In other words, the reception probe 121 is disposed such that the transmission sound axis AX1 and the reception sound axis AX2 are coaxial with each other. This arrangement is called coaxial setting. In the present disclosure, the eccentric distance L is not limited to zero.

In the present disclosure, as the set position of the reception probe 121, setting the transmission sound axis AX1 and the reception sound axis AX2 coaxial with each other is referred to as coaxial setting, while shifting the two sound axes (the transmission sound axis AX1 and the reception sound axis AX2) from each other (that is, eccentric setting) is referred to as eccentric setting. The present disclosure offers effects in both of a case of setting the reception probe 121 coaxially and a case of setting the reception probe 121 eccentrically. Therefore, the present disclosure includes both coaxial setting and eccentric setting as setting patterns of the reception probe 121.

In the present specification, in particular, when a reception setting position is specified, the reception probe 121 set coaxially is referred to as a reception probe 140 (coaxially set reception probe), and the reception probe 121 set eccentrically is referred to as a reception probe 120 (eccentrically set reception probe).

When it is simply stated as “reception probe 121”, therefore, whether the reception probe 121 is set coaxially or set eccentrically is not specified.

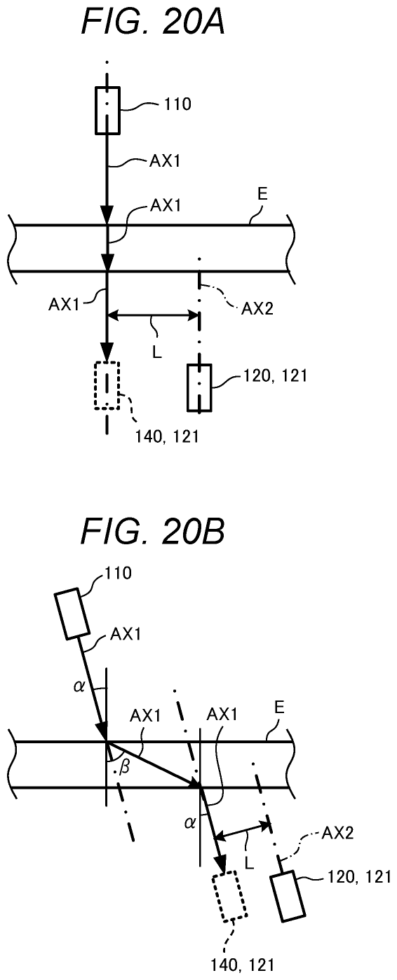

The sound axis is defined as the central axis of the ultrasonic beam U. The transmission sound axis AX1 is defined as a sound axis of a propagation path of the ultrasonic beam U emitted by the transmission probe 110. In other words, the transmission sound axis AX1 is the central axis of the propagation path of the ultrasonic beam U emitted by the transmission probe 110. As shown in FIG. 20B, which will be described later, the transmission sound axis AX1 includes refractions at interfaces of the inspection subject E. Specifically, as shown in FIG. 20B, when the ultrasonic beam U emitted from the transmission probe 110 is refracted at the interface of the inspection subject E, the center (sound axis) of the propagation path of the ultrasonic beam U is defined as the transmission sound axis AX1.

In addition, the reception sound axis AX2 is defined as a sound axis of a propagation path of a virtual ultrasonic beam in a hypothetical case where the reception probe 121 emits the ultrasonic beam U. In other words, the reception sound axis AX2 is the central axis of the virtual ultrasonic beam in the hypothetical case where the reception probe 121 emits the ultrasonic beam U.

As a specific example, a case of a non-convergent type reception probe with a flat probe surface will be described. In this case, the direction of the reception sound axis AX2 is normal to the probe surface and therefore an axis passing through the center point of the probe surface is the reception sound axis AX2. When the probe surface is a rectangular shape, the center point of the probe surface is defined as an intersection point of diagonal lines of the rectangular shape.

The control device 2 is connected to the scanning/measuring device 1. The control device 2, which controls driving of the scanning/measuring device 1, gives an instruction to the transmission probe scanning unit 103 and a reception probe scanning unit 104, thereby controlling movement (scanning) of the transmission probe 110 and the reception probe 121. The transmission probe scanning unit 103 and the reception probe scanning unit 104 move synchronously in the x-axis direction and the y-axis direction. This causes the transmission probe 110 and the reception probe 121 to scan the inspection subject E in the x-axis direction and the y-axis direction. In addition, the control device 2 causes the transmission probe 110 to emit the ultrasonic beam U, and carries out a waveform analysis, based on a signal acquired from the reception probe 121.

An example shown in the first embodiment is an example in which the transmission probe 110 and the reception probe 121 scan in a state where the inspection subject E is fixed to the enclosure 101 via the sample stage 102, that is, in a state where the inspection subject E is fixed to the enclosure 101. A configuration reverse to this example may also be adopted, in which configuration, as the transmission probe 110 and the reception probe 121 are fixed to the enclosure 101, the inspection subject E moves to perform scanning.

In the illustrated example, the gas G (an example of the fluid F, which may be replaced with the liquid W that will be described later) is present between the transmission probe 110 and the inspection subject E and between the reception probe 121 and the inspection subject E. This allows the transmission probe 110 and the reception probe 121 to probe without coming in contact with the inspection subject E, thus allowing relative positions of the transmission probe 110 and reception probe 121 on an xy plane to be changed smoothly and quickly. In other words, interposing the fluid F between the transmission probe 110 and the inspection subject E and between the reception probe 121 and the inspection subject E allows smooth scanning.

The transmission probe 110 is the convergent-type transmission probe 110. The reception probe 121 is, on the other hand, a probe with convergence property milder than that of the transmission probe 110. In this embodiment, a non-convergent type probe with a flat probe surface is used as the reception probe 121. By using this reception probe 121 of the non-convergent type, information on the defect part D can be collected in a wide range.

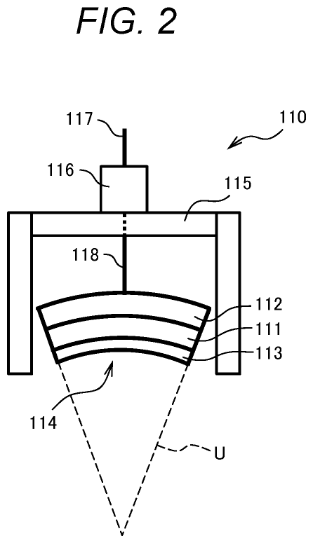

FIG. 2 is a schematic cross-sectional view of the structure of the transmission probe 110. In FIG. 2, for simplicity, only the outline of the emitted ultrasonic beam U is shown. Actually, however, a large number of ultrasonic beams U are emitted from the entire area of a probe surface 114 in the normal vector direction of the probe surface 114.

The transmission probe 110 is configured to converge the ultrasonic beam U. This allows highly accurate detection of the minute defect part D in the inspection subject E. The reason why the minute defect part D can be detected will be described later. The transmission probe 110 includes a transmission probe enclosure 115, and includes also a backing 112, a transducer 111, and a matching layer 113 that are inside the transmission probe enclosure 115. The transducer 111 is fitted with an electrode (not illustrated), which is connected to a connector 116 through a lead wire 118. The connector 116 is connected to a power supply device (not illustrated) and the control device 2 through a lead wire 117.

In the present specification, the probe surface 114 of the transmission probe 110 or the reception probe 121 is defined as a surface of the matching layer 113 when the matching layer 113 is provided, and is defined as a surface of the transducer 111 when the matching layer 113 is not provided. Specifically, the probe surface 114 of the transmission probe 110 is a surface that emits the ultrasonic beam U, while the probe surface 114 of the reception probe 121 is a surface that receives the ultrasonic beam U.

Now, as a comparative example, a conventional ultrasonic inspection method will be described.

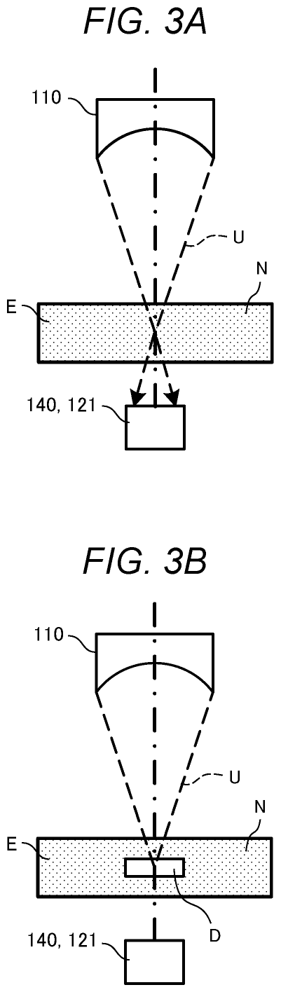

FIG. 3A depicts a propagation path of the ultrasonic beam U according to the conventional ultrasonic inspection method, showing a case where the ultrasonic beam U is incident on the sound part N. FIG. 3B depicts the propagation path of the ultrasonic beam U according to the conventional ultrasonic inspection method, showing a case where the ultrasonic beam U is incident on the defect part D. According to the conventional ultrasonic inspection method, for example, as described in PTL 1, the transmission probe 110 and the reception probe 140 serving as the reception probe 121 are arranged such that the transmission sound axis AX1 and the reception sound axis AX2 match.

As shown in FIG. 3A, when the ultrasonic beam U is incident on the sound part N of the inspection subject E, the ultrasonic beam U passes through the inspection subject E and reaches the reception probe 140. As a result, a reception signal increases in size. In contrast, as shown in FIG. 3B, when the ultrasonic beam U is incident on the defect part D, the defect part D blocks the ultrasonic beam U to prevent its transmission. As a result, the reception signal decreases in size. In this manner, the defect part D is detected based on a size decrease in the reception signal. This is what is described in PTL 1.

The method shown in FIGS. 3A and 3B, which is the method according to which the ultrasonic beam U is blocked at the defect part D to decrease the reception signal in size and the defect part D is detected based on the size decrease in the reception signal, is referred to as a “blocking method”.

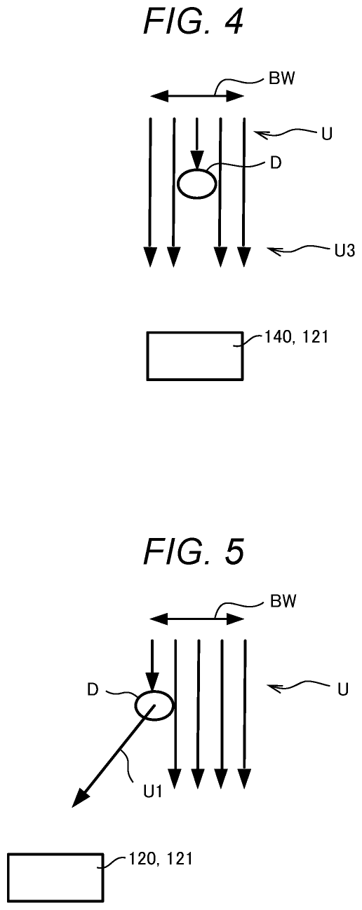

A problem with the above conventional technique is that when the defect size becomes smaller than the beam size, detection becomes difficult. This fact will be described with reference to FIG. 4A.

FIG. 4 depicts an interaction between the defect part D and the ultrasonic beam U in the inspection subject E, showing a state where a directly reaching ultrasonic beam U (which will hereinafter be referred to as “direct wave U3”) is received. The direct wave U3 will be described later. A case where the size of the defect part D is smaller than the width of the ultrasonic beam U (which will hereinafter be referred to as “beam width BW”) will now be discussed. The beam width BW is the width of the ultrasonic beam U at the point of time of it reaching the defect part D.

In FIG. 4, which schematically depicts the shape of the ultrasonic beam U in a minute area near the defect part D, the ultrasonic beam U is shown as a flux of parallel beams. Actually, however, the ultrasonic beam U is a converging beam. In addition, the position of the reception probe 121 is indicated in FIG. 4 as a conceptual position for understandable description. The position and shape of the reception probe 121 are therefore not accurately scaled. Specifically, according to a scale of enlargement of the shapes of the defect part D and the ultrasonic beam U, the reception probe 121 is actually at a position more distant from the defect part D in the vertical direction than its position shown in FIG. 4.

FIG. 4 shows a case of the blocking method by which the transmission sound axis AX1 and the reception sound axis AX2 are matched to each other. When the defect part D is smaller than the beam width BW, part of the ultrasonic beam U is blocked and therefore the reception signal decreases, but never decrease to zero. For example, when the cross-sectional area of the defect part D is 5% of a beam cross-sectional area defined by the beam width BW, the reception signal decreases by about 5% only, in which case detecting the defect part D is difficult. In the case shown in FIG. 4, the reception signal decreases by 5% only at a spot where the defect part D is present. In this manner, in the case where the defect part D is smaller than the beam width BW, beams traveling straight without interacting with the defect part D increase, which makes defect detection difficult.

FIG. 5 is a schematic view of a scattered wave U1 that is the ultrasonic beam U having interacted with the defect part D. In the present specification, the ultrasonic beam U having interacted with the defect part D is referred to as the scattered wave U1. The term “scattered wave U1” in the present specification, therefore, refers to an ultrasonic wave having interacted with the defect part D. The scattered wave U1 includes a wave that changes its direction as shown in FIG. 5. The scattered wave U1 includes also a wave that changes at least in phase or frequency because of its interaction with the defect part D but does not change in traveling direction. An ultrasonic wave that travels through without interacting with the defect part D is referred to as a direct wave U3. If only the scattered wave U1 can be detected in separation from the direct wave U3, the defect part D of a small size can be easily detected. In the present disclosure, the scattered wave U1 is efficiently detected by paying attention to a difference in frequency.

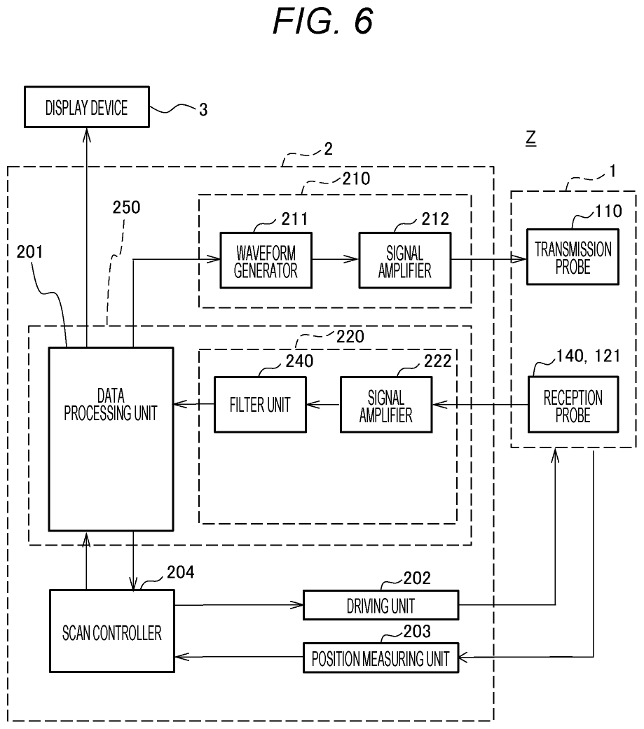

FIG. 6 is a functional block diagram of the control device 2. The control device 2 controls driving of the scanning/measuring device 1. The control device 2 includes a transmission system 210, a reception system 220, a data processing unit 201, a scan controller 204, a driving unit 202, a position measurement unit 203, and a signal processing unit 250. The reception system 220 and the data processing unit 201 are collectively referred to as the signal processing unit 250. The signal processing unit 250 carries out signal processing of extracting significant information from a signal from the reception probe 121 through amplifying, filtering, or the like.

The transmission system 210 is a system that generates a voltage applied to the transmission probe 110. The transmission system 210 includes a waveform generator 211 and a signal amplifier 212. The waveform generator 211 generates a burst wave signal. The generated burst wave signal is amplified by the signal amplifier 212. A voltage outputted from the signal amplifier 212 is applied to the transmission probe 110.

The signal processing unit 250 includes the reception system 220. The reception system 220 is a system that detects a reception signal outputted from the reception probe 121. A signal outputted from the reception probe 121 is inputted to the signal amplifier 222, which amplifies the signal. The amplified signal is inputted to a filter unit 240 (cutoff filter). The filter unit 240 reduces (cuts off) components in a specific frequency range of the input signal. The filter unit 240 will be described later. An output signal from the filter unit 240 is inputted to the data processing unit 201.

The data processing unit 201 generates signal intensity data from the incoming signal from the filter unit 240. In the present embodiment, a peak-to-peak signal volume is used as a method of generating signal intensity data. The peak-to-peak signal volume represents the difference between the maximum value and the minimum of the signal. Another method of generating the signal intensity data may be adopted, which method is to use the intensity of a frequency component in a specific frequency range that is obtained by Fourier transform.

The data processing unit 201 also receives information on a scanning position, from the scan controller 204. In this manner, the value of signal intensity data at the current two-dimensional scanning position (x, y) is obtained. Plotting the value of signal intensity data with respect to the scanning position yields an image (defect image) corresponding to at least either the position or the shape of the defect part D. This defect image is outputted to the display device 3.

### Filter Unit 240

In the present specification, the filter unit 240 is defined as a control unit that carries out signal processing of reducing the intensity of signal components in a given frequency range. Filtering is defined as signal processing of reducing the intensity of signal components in a given frequency range. When a reception signal is decomposed into respective component intensities of frequency components by Fourier transform or the like, a frequency at which the component intensity reaches the maximum is referred to as a maximum component frequency. A maximum intensity frequency component is a frequency component at the maximum component frequency. The filter unit 240 of the present specification reduces the intensity of a signal component in the fundamental waveband including the maximum intensity frequency component, that is, the frequency range including the maximum component frequency. A distribution of respective component intensities of frequency components is referred to as a frequency spectrum.

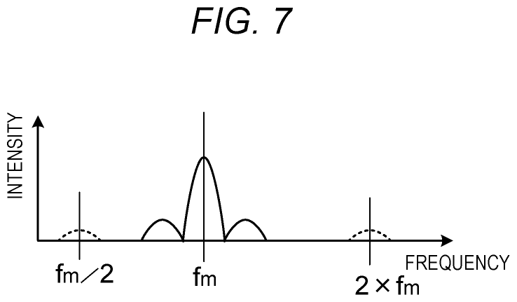

FIG. 7 is a schematic view of distribution of frequency components (frequency spectrum) of a reception signal. The filter unit 240 will be described more specifically with reference to FIG. 7. In FIG. 7, the horizontal axis represents frequency and the vertical axis represents component intensity. The vertical axis is plotted with a logarithmic scale, thus schematically showing a wide intensity range.

The maximum component frequency at which the component intensity reaches the maximum is denoted as fm. The maximum component frequency fm is approximately equal to the fundamental frequency f0 of a burst wave transmitted from the transmission probe 110. The frequency components of the signal spread at the front and rear of the maximum component frequency fm, and this frequency component spread is referred to as a fundamental waveband W1.

A component with a frequency N times the maximum component frequency fm (N×fm) is a harmonic. A component with a frequency 1/N times the maximum component frequency fm (fm/N) is a sub-harmonic. N denotes an integer equal to or larger than 2. The harmonic and the sub-harmonic each have a frequency component spread. In the present specification, in a particular case where the harmonic and sub-harmonic's having their respective frequency spreads is emphasized, those frequency spreads are referred to as a harmonic band and a sub-harmonic band, respectively. Therefore, even simply saying “harmonic” implies the fact that the harmonic has a frequency spread. The harmonic band and the sub-harmonic band are created in a nonlinear phenomenon. They are created when the sound pressure of the ultrasonic beam U inputted to the inspection subject E is extremely strong.

In the case where the gas G is present between the transmission probe 110 and the inspection subject E, as is in the first embodiment, sending the ultrasonic beam U with a high sound pressure into the inspection subject E is generally difficult. In such a case, therefore, at least either the harmonic band or the sub-harmonic band is not observed in many cases. Under the conditions applied in the first embodiment, the harmonic band and the sub-harmonic band are out of a detection limit.

As shown in FIG. 7, the fundamental waveband W1 has a frequency spread. Among frequency components making up the fundamental waveband W1, frequency components other than the component at the maximum component frequency fm are referred to as a “skirt component W3”. The skirt component W3 includes side lobes of the fundamental wave.

In the first embodiment, the filter unit 240 reduces a component intensity in a cutoff frequency range including the maximum component frequency fm. In other words, the filter unit 240 reduces at least the maximum intensity frequency component (component corresponding to the maximum component frequency fm) of the reception signal of the reception probe 121. The filter unit 240 then detects the skirt component W3 in the fundamental waveband W1 including the maximum intensity frequency component, the skirt component W3 being a part of the fundamental waveband W1 that is other than the maximum intensity frequency component. Because the component intensity in the cutoff frequency range is reduced by the filter unit 240, the proportion of the skirt component W3 in the fundamental waveband W1 increases in the signal having passed through the filter unit 240. This process, as it will be described later, improves a capability to defect the defect part D.

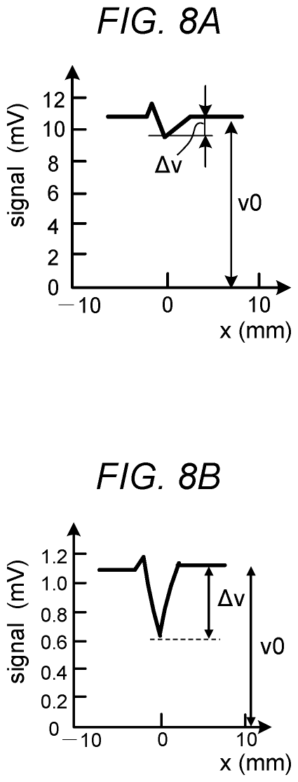

FIG. 8A depicts a position-dependent change in signal intensity information that results when the transmission probe 110 and the reception probe 121 scan across the defect part D. FIG. 8A shows a measurement result that is obtained using the functional configuration of FIG. 6 from which the filter unit 240 is removed. The signal intensity at the sound part N is v0. Meanwhile, the signal intensity decreases by Δv at the position corresponding to the defect part D (x=0), which means that the defect part D has been successfully detected. However, a change rate of the signal intensity (Δv/v0) is small. The change rate of the signal intensity is defined as a value given by dividing a signal variation Av at the defect part D by the signal intensity v0 at the sound part N.

FIG. 8B depicts a result of measurement of the signal intensity by the control device 2 including the filter unit 240 (FIG. 6). FIG. 8B demonstrates that the change rate of the signal intensity (Δv/v0) at the defect part D has increased to improve the detectability of the defect part D.

Experimental conditions in which the experimental results of FIGS. 8A and 8B are incorporated will be described.

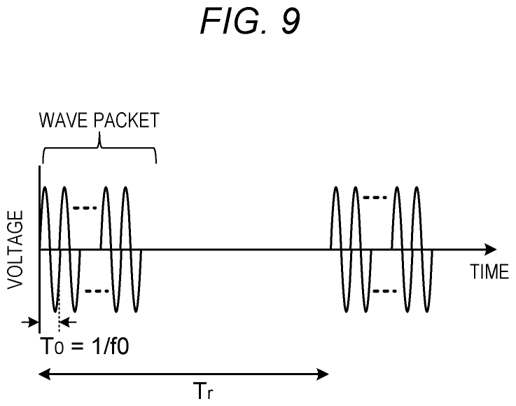

FIG. 9 depicts the voltage waveform of a burst wave applied to the transmission probe 110. The horizontal axis represents time, and the vertical axis represents voltage. 10 sinusoidal waves each having a fundamental frequency f0 of 0.82 MHz have been applied to the transmission probe 110. These 10 waves are referred to as a wave packet. The reciprocal of the fundamental frequency f0 is referred to as a fundamental period T0. As shown in FIG. 9, the fundamental period T0 is the period of waves making up one wave packet. The wave packet has been applied at a repetition period Tr=5 ms.

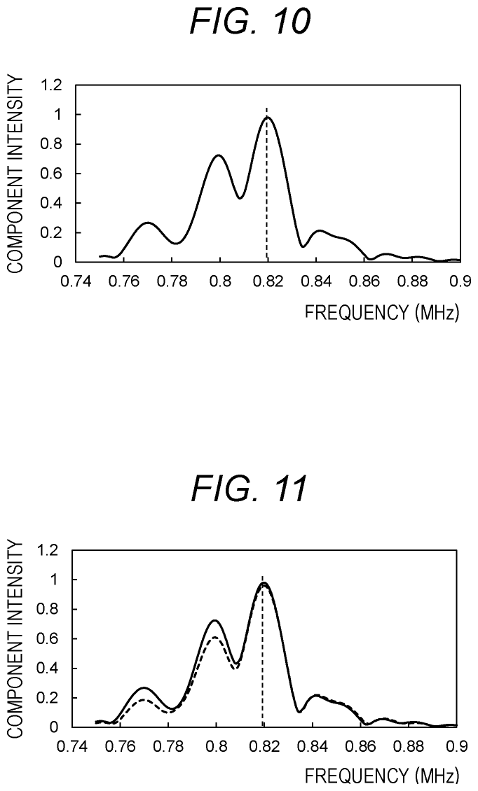

FIG. 10 depicts a frequency component distribution of a reception signal under conditions indicated in FIG. 9. In FIG. 10, the horizontal axis represents frequency, and the vertical axis represents measurement data on component intensities at different frequencies. This is a frequency component distribution of a signal that is not processed by the filter unit 240. 0.82 MHz, at which the component intensity reaches the maximum, is the maximum component frequency fm. The fundamental waveband W1 spreads from 0.74 MHz to 0.88 MHz, and among the components making up the fundamental waveband W1, the components other than the component at the maximum component frequency fm are the skirt component W3. In this embodiment, the maximum component frequency fm is equal to the fundamental frequency f0 of the ultrasonic wave transmitted by the transmission probe 110. In this manner, in many cases, the maximum component frequency fm is approximately equal to the fundamental frequency f0 of the transmitted ultrasonic wave.

As described above, the filter unit 240 (FIG. 6) cuts off the maximum component frequency fm. Specifically, in the illustrated example, the filter unit 240 (FIG. 6) transmits the skirt component W3 of 0.78 MHz or lower but cuts off waves with frequencies higher than 0.78 MHz including the maximum component frequency of 0.82 MHz. It is understood that using such a filter unit 240 increases the change rate of the signal intensity at the defect part D, thus significantly improving defect detectability, as indicated in FIG. 8B.

FIG. 11 is a graph in which measurement data of a frequency component distribution (frequency spectrum) of a reception signal, the measurement data being data on the sound part N (continuous line), and measurement data of a frequency component distribution (frequency spectrum) of a reception signal, the measurement data being data on the defect part D (broken line), are compared with each other. A mechanism by which the filter unit 240 improves the detectability of the defect part D is as follows. At the maximum component frequency fm=0.82 MHz, a component intensity difference (a signal size difference) between the sound part N and the defect part D is small. In contrast, the difference between the sound part N and the defect part D is large in the skirt component W3 other than the component corresponding to the maximum component frequency fm, particularly in a low band.

In this manner, the inventors have examined the frequency components of the reception signal and found that the difference between the sound part N and the defect part D is larger in the skirt component W3 than in the component corresponding to the maximum component frequency fm. Based on this finding, the inventors have reached a conclusion that by using the filter unit 240 that reduces the frequency component of the maximum component frequency fm at which the difference between the sound part N and the defect part D is small, the detectability of the defect part D can be improved.

In this manner, the present disclosure is based on the new knowledge discovered by the inventors that in the frequency component distribution of the reception signal, the signal change rate at the defect part D is larger in the skirt component W3 of the fundamental waveband W1 than in the signal component at the maximum component frequency fm. The component at the maximum component frequency fm occupies a large proportion of the reception signal but shows a small signal change rate at the defect part D. Reducing this component, therefore, increases the proportion of a portion occupied by the skirt component W3 as a consequence. Through this process, the signal having been processed by the filter unit 240 shows an increased signal change rate at the defect part D, which improves the detectability of the defect part D. Besides, comparing the measurement data shown in FIGS. 8A and 8B clearly indicates the effect of improving the detectability of the defect part D that the filter unit 240 offers.

A typical example of the frequency characteristics of the filter unit 240 that offers the effects of the present disclosure will be described below. It is preferable that the filter unit 240 include at least one of a band elimination filter, a low-pass filter, or a high-pass filter. By including at least one of these filters, the filter unit 240 is able to reduce components in the frequency range including the maximum component frequency fm. In particular, the filter unit 240 including at least either the low-pass filter or the high-pass filter cuts off only the high-frequency component or low-frequency component, in which case a program for frequency cutoff can be simplified. In addition, when the filter unit 240 is incorporated in an electronic circuit, a circuit configuration for frequency cutoff can be simplified.

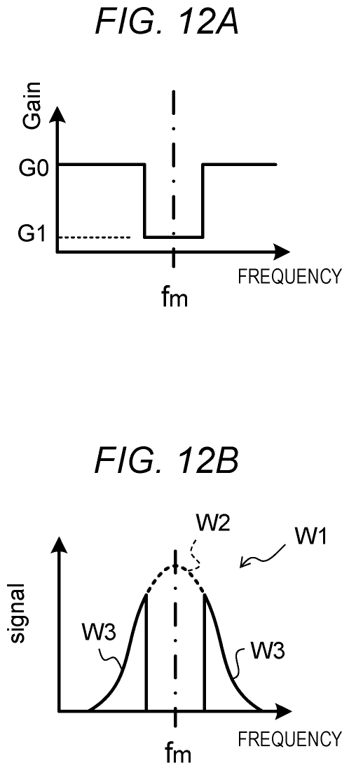

FIG. 12A depicts frequency characteristics of a gain of the band elimination filter. The band elimination filter reduces components in a frequency range W2 (FIG. 12B) including the maximum component frequency fm, the frequency range W2 being included in the fundamental waveband W1 (FIG. 12B) including the maximum component frequency fm (maximum intensity frequency component). A reduction rate x is defined as a ratio G1/G0 that is a ratio between a gain G0 in a transmission area and a gain G1 in a cutoff area. In the first embodiment, the reduction rate x is set to −20 dB (1/10) to −40 dB (1/100).

FIG. 12 B is a schematic view of frequency characteristics of a signal having been processed by the band elimination filter. A waveform indicated by a continuous line and a dotted line is the fundamental waveband W1. The dotted line indicates a signal component before being processed, and the component in the frequency range W2 indicated by the dotted line is reduced by the band elimination filter. As a result, the skirt component W3 of the fundamental waveband W1, the skirt component W3 being indicated by the continuous line, can be detected.

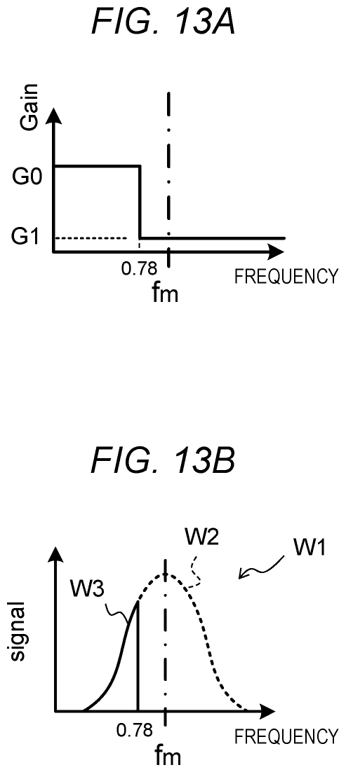

FIG. 13A depicts frequency characteristics of a gain of the low-pass filter. By setting a cutoff frequency lower than the maximum component frequency fm, a signal component at the maximum component frequency fm can be reduced. In the first embodiment, the cutoff frequency is set to 0.78 MHz. Specifically, the cutoff frequency is set 40 kHz lower than the maximum component frequency fm. The reduction rate at a cutoff part is set to about −40 dB.

FIG. 13B is a schematic view of frequency characteristics of a signal having been processed by the low-pass filter. A dotted line and a continuous line in FIG. 13B indicate the same elements as indicated in FIG. 12B. When the low-pass filter is used, a frequency component smaller than the maximum component frequency fm among frequency components making up the skirt component W3 can be detected, as indicated by the continuous line.

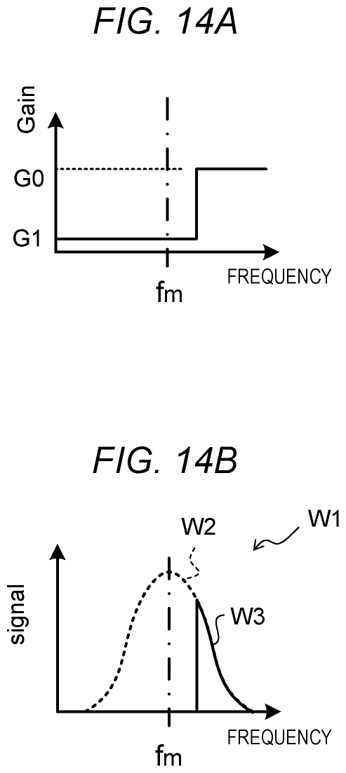

FIG. 14A depicts frequency characteristics of a gain of the high-pass filter. By setting a cutoff frequency higher than the maximum component frequency fm, the signal component at the maximum component frequency fm can be reduced.

FIG. 14B is a schematic view of frequency characteristics of a signal having been processed by the high-pass filter. A dotted line and a continuous line in FIG. 13B indicate the same elements as indicated in FIG. 12B. When the high-pass filter is used, a frequency component larger than the maximum component frequency fm among frequency components making up the skirt component W3 can be detected, as indicated by the continuous line.

### Method of Configuring Filter Unit 240

A typical example of a method of configuring the filter unit 240 will be described below. Methods of configuring the filter unit 240 are roughly classified into a method for an analog type and a method for a digital type.

The analog type is a filter unit that reduce a signal component in an intended frequency range, using an analog circuit. Typical examples of the frequency characteristics of the filter unit 240 are the frequency characteristics of the band elimination filter (FIGS. 12A and 12B), of the low-pass filter (FIGS. 13A and 13B), and of the high-pass filter (FIGS. 14A and 14B). Various methods of providing analog circuits having such frequency characteristics are already known.

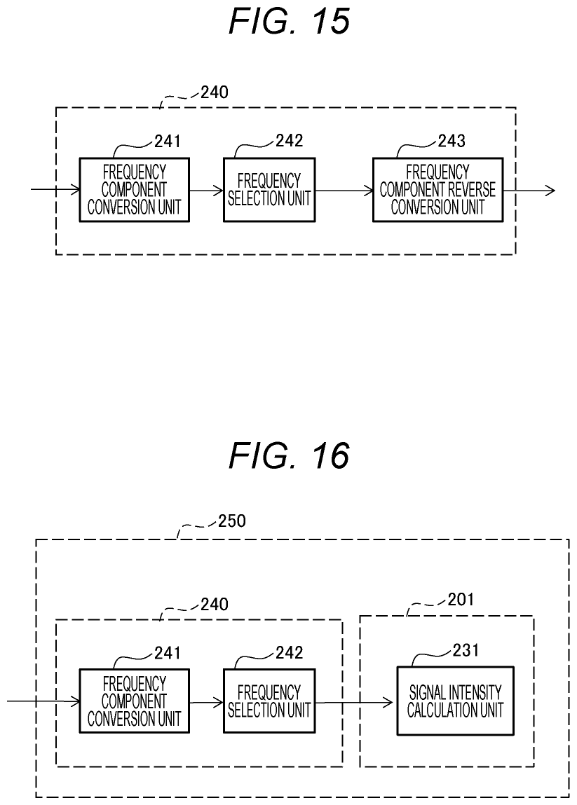

FIG. 15 is a block diagram of the filter unit 240 of a digital type. This filter unit 240 includes a frequency component conversion unit 241, a frequency selection unit 242, and a frequency component reverse conversion unit 243. The frequency component conversion unit 241 converts a reception signal of the reception probe 121, the reception signal being input from the signal amplifier 222, into a frequency component. The frequency selection unit 242 selects the skirt component W3 by removing a frequency band including the maximum component frequency fm (maximum intensity frequency component). The frequency component reverse conversion unit 243 converts only the necessary frequency components back into a time domain signal. Among these units, the filter unit 240 of the digital type particularly needs the frequency component conversion unit 241 and the frequency selection unit 242 to be configured as the digital type.

Such a filter unit 240 of the digital type can also reduce components in the frequency range including the maximum component frequency fm. A process carried out by the frequency component conversion unit 241 is a process of converting a signal waveform in the time domain into frequency components, which is, typically, Fourier transform. A process carried out by the frequency component reverse conversion unit 243 is a process of converting frequency components (frequency spectrum) back into a signal waveform in the time domain, which is, typically, reverse Fourier reverse.

FIG. 16 is a block diagram of a filter unit 240 according to a different embodiment. The filter unit 240 is disposed in the signal processing unit 250. The filter unit 240 includes the frequency component conversion unit 241 and the frequency selection unit 242. Output from the frequency selection unit 242 is inputted to a signal intensity calculation unit 231 in the data processing unit 201. The signal intensity calculation unit 231 calculates signal intensity, based on frequency component information.

As indicated in the frequency spectra of FIG. 11, the reason the skirt component W3 of the fundamental waveband W1 changes in sensitive to the defect part D is explained as follows.

The direct wave U3, which does not interact with the defect part D, does not change in propagation direction, phase, frequency, etc. A larger proportion of the signal component at the maximum component frequency fm is therefore occupied by the direct wave U3. Hence a difference between the defect part D and the sound part N turns out small.

As shown in FIG. 5, the scattered wave U1 interacting with the defect part D includes a component that changes in propagation direction and a component that does not change in propagation direction but changes at least in phase or frequency. In the skirt component W3 of the fundamental waveband W1, the skirt component W3 being a component shifted from the maximum component frequency fm, therefore, the proportion of the scattered wave U1, which is the ultrasonic beam U having interacted with the defect part D, increases. This results in a larger difference between the defect part D and the sound part N. In this manner, by reducing the component at the maximum component frequency fm and detecting the skirt component W3 of the fundamental waveband W1, the capability to detect the defect part D can be improved.

### Focal Distance of Reception Probe

It is more preferable that the focal distance R2 of the reception probe 121 be longer than the focal distance R1 of the transmission probe 110. This is because that the focal distance R2 longer than the focal distance R1 allows detection of more scattered wave U1 components, which will be described later. As described above, since the scattered wave U1 is the ultrasonic beam U having interacted with the defect part D, an increase in the proportion of the scattered wave U1 components makes detection of the defect part D easier.

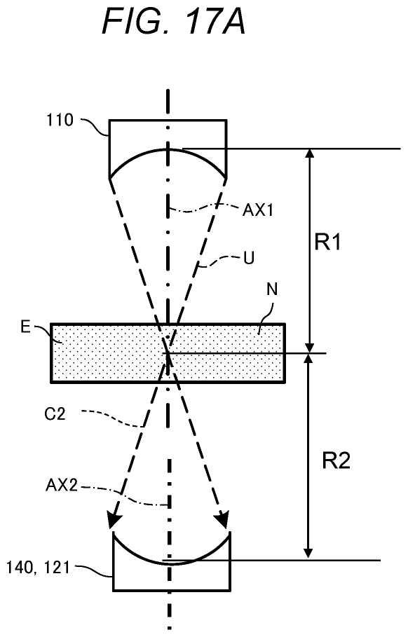

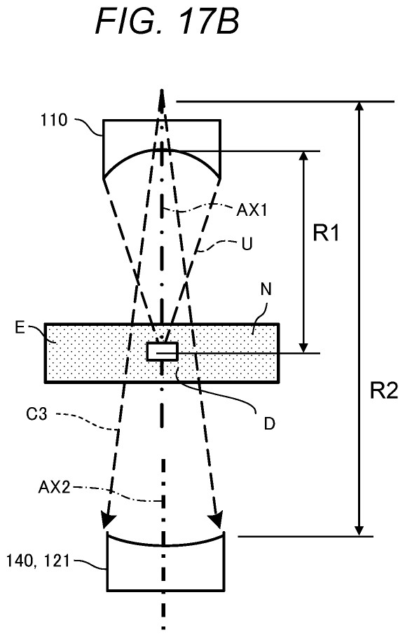

The reason why the longer focal distance of the reception probe 121 allows detection of more scattered wave components will be described with reference to FIGS. 17A and 17B.

FIG. 17A is a schematic view of a propagation path of the ultrasonic beam U in a case where the focal distance R1 of the transmission probe 110 is set equal to the focal distance R2 of the reception probe 121. A cone C3 will be described in FIG. 17B. In the example shown in FIG. 17A, a convergence point of the ultrasonic beam U transmitted from the transmission probe 110 coincides with a convergence point of a virtual beam virtually emitted from the reception probe 121. Therefore, the ultrasonic beam U whose propagation direction is not changed at the defect part D can be received efficiently. However, the ultrasonic beam U whose propagation direction has been changed at the defect part D is difficult to detect.

FIG. 17B is a schematic view of a propagation path of the ultrasonic beam U in a case where the focal distance R2 of the reception probe 121 is set longer than the focal distance R1 of the transmission probe 110. The reception probe 121 can detect the ultrasonic beam U within the range of the cone (shape) C3 of the virtual beam virtually emitted from the reception probe 121. In this case, even the scattered wave U1 whose propagation direction is slightly changed at the defect part D can be detected if the scattered wave U1 is within the range of the cone C3. In this manner, by setting the focal distance R2 of the reception probe 121 longer than the focal distance R1 of the transmission probe 110, the detectable scattered wave U1 can be increased. As mentioned above, the scattered wave U1 is the wave having interacted with the defect part D. The capability to detect the defect part D, therefore, can be further improved.

The acuteness/mildness of convergence is defined by a size relationship between a beam incident area T1 and a beam incident area T2 on the surface of the inspection subject E. The beam incident areas T1 and T2 will be described.

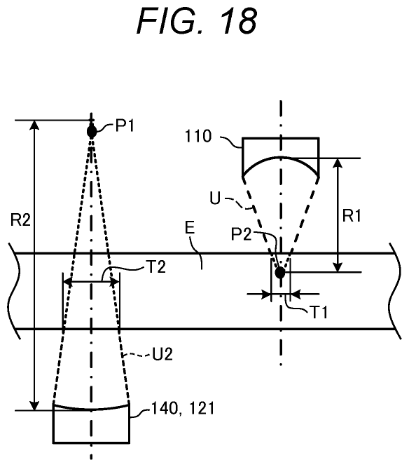

FIG. 18 is a diagram for explaining a relationship between the beam incident area T1 of the transmission probe 110 and the beam incident area T2 of the reception probe 121. The beam incident area T1 of the transmission probe 110 on the inspection subject E is an intersection area on the surface of the inspection subject E, the intersection area being an area where the ultrasonic beam U emitted from the transmission probe 110 intersects the surface of the inspection subject E. The beam incident area T2 of the reception probe 121 is an intersection area where the virtual ultrasonic beam U2 intersects the surface of the inspection subject E, the virtual ultrasonic beam U2 being defined in a hypothetical situation where the ultrasonic beam U is emitted from the reception probe 121.

In FIG. 18, the path of the ultrasonic beam U is indicated as the path in a case where the inspection subject E is not present. When the inspection subject E is present, the ultrasonic beam U is refracted on the surface of the inspection subject E and consequently propagates through a path different from the path indicated by broken lines. As shown in FIG. 18, the beam incident area T2 of the reception probe 121 on the inspection subject E is larger than the beam incident area T1 of the transmission probe 110 on the inspection subject E. In this configuration, the convergence of the reception probe 121 is made milder than the convergence of the transmission probe 110.

In addition, the focal distance R2 of the reception probe 121 is longer than the focal distance R1 of the transmission probe 110. This also makes the convergence of the reception probe 121 milder than the convergence of the transmission probe 110. At this time, the distance from the inspection subject E to the transmission probe 110 and the distance from the same to the reception probe 121 are, for example, equal. Both distances, however, may not be equal.

As described above, in this embodiment, the convergence of the reception probe 121 is made milder than the convergence of the transmission probe 110. In other words, the focal distance R2 of the reception probe 121 is set longer than the focal distance R1 of the transmission probe 110. As a result, the beam incident area T2 of the reception probe 121 gets wider, which allows detection of the scattered wave U1 in a wide range. Even if the propagation path of the scattered wave U1 slightly changes, therefore, the reception probe 121 is able to detect the scattered wave U1. Hence the defect part D can be detected in a wide range.

The focal point P1 of the reception probe 121 is closer to the transmission probe 110 (the upper part of FIG. 18) than the focal point P2 of the transmission probe 110. Shifting the focal points P1 and P2 from each other in this manner makes it easier for the reception probe 121 to receive the scattered wave U1 and therefore to detect the scattered wave U1.

As a configuration in which the focal distance R2 of the reception probe 121 is set longer than the focal distance R1 of the transmission probe 110, a non-convergent type probe (not illustrated) may be used as the reception probe 121. The focal distance R2 of the non-convergent type probe is infinitely large and is therefore longer than the focal distance R1 of the transmission probe 110. In other words, at the reception probe 121 of the non-convergence type, the convergence of the reception probe 121 is milder than the convergence of the transmission probe 110.

### Second Embodiment

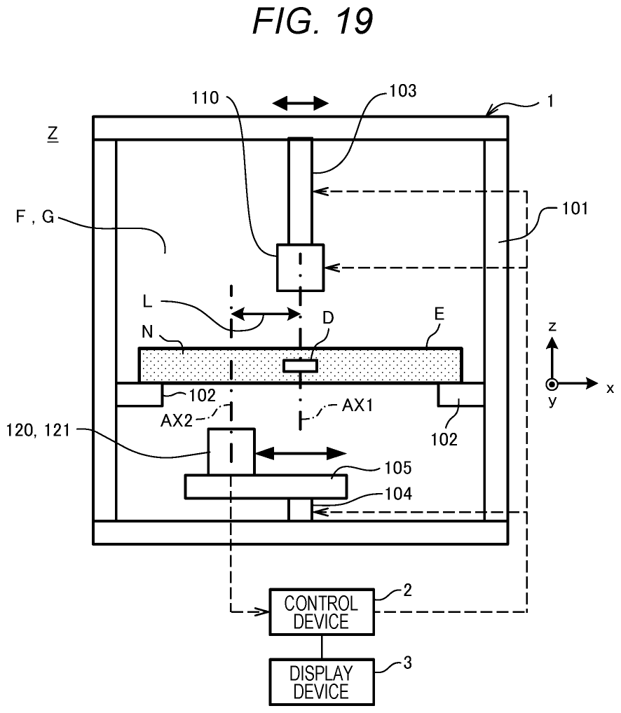

FIG. 19 depicts a configuration of an ultrasonic inspection apparatus Z according to a second embodiment. In the second embodiment, the transmission sound axis AX1 of the transmission probe 110 and the reception sound axis AX2 of the reception probe 121 are set shifted from each other. In other words, the reception probe 121 in the second embodiment is the reception probe 120 (eccentrically set reception probe) having the reception sound axis AX2 located at a position different from the position of the transmission sound axis AX1 of the transmission probe 110. Therefore, the eccentric distance L (distance) between the transmission sound axis AX1 (sound axis) of the transmission probe 110 and the reception sound axis AX (sound axis) of the reception probe 120 is larger than 0.

In this arrangement, a wave whose spatial direction has changed, the wave being among a group of scattered waves U1, can be detected. By combining a frequency-wise scattered wave U1 extraction principle using the filter unit 240 (FIG. 6) with a spacial scattered wave U1 extraction principle using eccentric setting, the detectability of the defect part D can be further improved.

In the second embodiment, the reception probe 120 is shifted by the eccentric distance L in the x-axis direction of FIG. 19, relative to the transmission probe 110. The reception probe 120, however, may be shifted in the y-axis direction of FIG. 19. In another case, the reception probe 120 may be disposed at a position shifted from the transmission probe 110 by L1 in the x-axis direction and by L2 in the y-axis direction (that is, at a position defined by coordinates (L1, L2) on the xy plane where the transmission probe 110 at its origin).

FIG. 20A is a diagram for explaining the transmission sound axis AX1, the reception sound axis AX2, and the eccentric distance L, showing a case where the transmission sound axis AX1 and the reception sound axis AX2 extend in the vertical direction. FIG. 20B is a diagram for explaining the transmission sound axis AX1, the reception sound axis AX2, and the eccentric distance L, showing a case where the transmission sound axis AX1 and the reception sound axis AX2 extend slantly. In each of FIGS. 20A and 20B, the reception probe 140 (coaxially set reception probe) is also indicated by a broken line for reference.

The sound axis is defined as the central axis of the ultrasonic beam U. The transmission sound axis AX1 is defined as a sound axis of a propagation path of the ultrasonic beam U emitted by the transmission probe 110. In other words, the transmission sound axis AX1 is the central axis of the propagation path of the ultrasonic beam U emitted by the transmission probe 110. As shown in FIG. 20B, the transmission sound axis AX1 includes refractions at the interfaces of the inspection subject E. Specifically, as shown in FIG. 20B, when the ultrasonic beam U emitted from the transmission probe 110 is refracted at the interface of the inspection subject E, the center (sound axis) of the propagation path of the ultrasonic beam U is defined as the transmission sound axis AX1.

In addition, the reception sound axis AX2 is defined as a sound axis of a propagation path of a virtual ultrasonic beam in a hypothetical case where the reception probe 121 emits the ultrasonic beam U. In other words, the reception sound axis AX2 is the central axis of the virtual ultrasonic beam in the hypothetical case where the reception probe 121 emits the ultrasonic beam U.

As a specific example, a case of a non-convergent type reception probe with a flat probe surface (not illustrated) will be described. In this case, the direction of the reception sound axis AX2 is normal to the probe surface and therefore an axis passing through the center point of the probe surface is the reception sound axis AX2. When the probe surface is a rectangular shape, the center point of the probe surface is defined as an intersection point of diagonal lines of the rectangular shape.

The reason the direction of the reception sound axis AX2 is normal to the probe surface is that the virtual ultrasonic beam U emitted from the reception probe 121 travels in the direction normal to the probe surface. When the ultrasonic beam U is received, the ultrasonic beam U incoming in the direction normal to the probe surface can be received with high sensitivity.

The eccentric distance L is defined as the distance of shift between the transmission sound axis AX1 and the reception sound axis AX2. Therefore, when the ultrasonic beam U emitted from the transmission probe 110 is refracted, as shown in FIG. 20B, the eccentric distance L is defined as the distance of shift between the refracted transmission sound axis AX1 and the reception sound axis AX2. In the ultrasonic inspection apparatus Z of the second embodiment, the transmission probe 110 and the reception probe 120 are adjusted by an eccentric distance adjustment unit 105 (FIG. 19) such that the eccentric distance L defined above is a distance larger than 0.

FIG. 20A depicts a case where the transmission probe 110 is disposed in the direction normal to the surface of the inspection subject E. In FIGS. 20A and 20B, the transmission sound axis AX1 is indicated by a continuous line arrow. The reception sound axis AX2 is indicated by a single-dotted chain line arrow. In FIGS. 20A and 20B, the position of the reception probe 121 that is indicated by a broken line is the position at which the eccentric distance L is 0, and the reception probe 121 with the reception sound axis AX2 matching the transmission sound axis AX1 is the reception probe 140 as the coaxially set reception probe. The reception probe 121 indicated by a continuous line is the reception probe 120 (eccentrically set reception probe) disposed at a position at which the eccentric distance L is larger than 0. When the transmission probe 110 is set such that the transmission sound axis AX1 is perpendicular to a horizontal plane (the xy plane in FIG. 19), the propagation path of the ultrasonic beam U is not refracted. In other words, the transmission sound axis AX1 is not refracted.

FIG. 20B depicts a case where the transmission probe 110 is set tilted by an angle α against the direction normal to the surface of the inspection subject E. In FIG. 20B, the transmission sound axis AX1 is indicated by a continuous line arrow and the reception sound axis AX2 is indicated by a single-dot chain line arrow, in the same manner as in FIG. 20A. In the example shown in FIG. 20B, as described above, the propagation path of the ultrasonic beam U is refracted by a refraction angle β at the interface between the inspection subject E and the fluid F. The transmission sound axis AX1 is, therefore, bent (refracted) in a pattern indicated by continuous line arrows in FIG. 20B. In this case, the position of the reception probe 140 that is indicated by the broken line is the position at which the eccentric distance L is 0, that is, the position at which the reception probe 140 is on the transmission sound axis AX1. As described above, even in the case where the ultrasonic beam U is refracted, the reception probe 120 is set such that the distance between the transmission sound axis AX1 and the reception sound axis AX2 is L. In the example shown in FIG. 19, because the transmission probe 110 is disposed in the direction normal to the surface of the inspection subject E, the eccentric distance L is provided as the eccentric distance L shown in FIG. 20A.

It is more preferable that the eccentric distance L be set in such a way as to provide a positional relationship that makes signal intensity at the defect part D larger than reception signal intensity at the sound part N of the inspection subject E.

### Third Embodiment

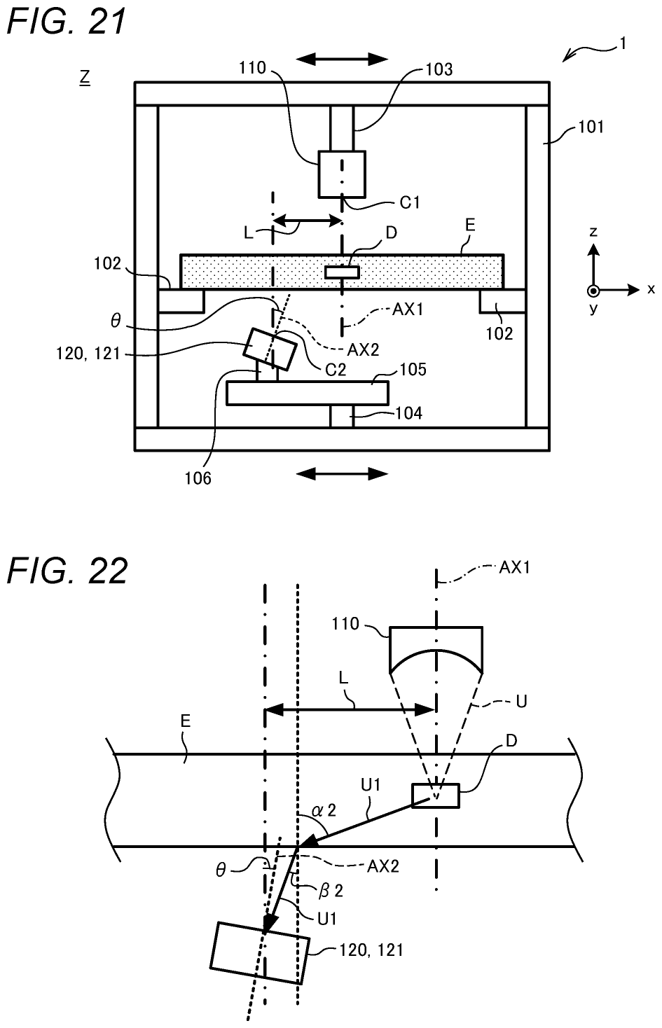

FIG. 21 depicts a configuration of an ultrasonic inspection apparatus according to a third embodiment. In the third embodiment, the scanning/measuring device 1 includes a set angle adjustment unit 106 that adjusts a tilt of the reception probe 120. This allows the intensity of a reception signal to be increased, thus allowing the SN ratio (signal-to-noise ratio) of the signal to be increased. The set angle adjustment unit 106 is composed of, for example, an actuator, a motor, and the like, which are not illustrated.

Now, an angle θ that the transmission sound axis AX1 and the reception sound axis AX2 make is defined as a reception probe set angle. In the case of FIG. 21, because the transmission probe 110 is set in the vertical direction to align the transmission sound axis AX1 with the vertical direction, the angle θ, which is the reception probe set angle, is an angle that the transmission sound axis AX1 (i.e., the vertical direction) and the normal to the probe surface of the reception probe 120 make. The set angle adjustment unit 106 tilts the reception probe 120 by the angle θ toward the side where the transmission sound axis AX1 is present in such a way as to set the angle θ larger than 0. The reception probe 120 is thus set in a tilted position. Specifically, the reception probe 120 is set in a tilted position that satisfies 0°<θ<90°, where the angle θ is, for example, 10° but is not limited to 10°.

The eccentric distance L when the reception probe 120 is set in a tilted position is defined as follows. An intersection point between the reception sound axis AX2 and the probe surface of the reception probe 120 is defined as an intersection point C2. Likewise, an intersection point between the transmission sound axis AX1 and the probe surface of the transmission probe 110 is defined as an intersection point C1. The distance between a coordinate position (x4, y4) (not illustrated), which is the result of projection of the position of the intersection point C1 onto the xy plane, and a coordinate position (x5, y5) (not illustrated), which is the result of projection of the position of the intersection point C2 onto the xy plane, is defined as the eccentric distance L.

The inventors have set the reception probe 120 in such a tilted position and actually detected the defect part D, and found that the signal intensity of the reception signal has increased threefold, compared with the case of θ=0.

FIG. 22 is a diagram for explaining the reason why the effects of the third embodiment are produced. The scattered wave U1 propagates in a direction deviating from the transmission sound axis AX1. Therefore, as shown in FIG. 22, when the scattered wave U1 reaches the exterior surface of the inspection subject E, the scattered wave U1 is incident on the interface between the inspection subject E and the outside at a non-zero angle α2 that a vector normal to the surface of the inspection subject E and the scattered wave U1 make. The angle of the scattered wave U1 coming out of the surface of inspection subject E is an angle β2 that is a non-zero emission angle against the direction normal to the surface of inspection subject E. The scattered wave U1 is received most efficiently when the vector normal to the probe surface of the reception probe 120 is matched to the traveling direction of the scattered wave U1. In other words, setting the reception probe 120 in a tilted position increases the intensity of the reception signal.

When the angle β2 of the ultrasonic beam U emitted from the inspection subject E matches the angle θ the transmission sound axis AX1 and the reception sound axis AX2 make, a reception effect becomes the highest. However, even when the angle β2 and the angle θ do not match completely, the effect of increasing the reception signal can be obtained. The case of FIG. 22, where the angle β2 and the angle θ do not match completely, therefore, is acceptable.

### Fourth Embodiment

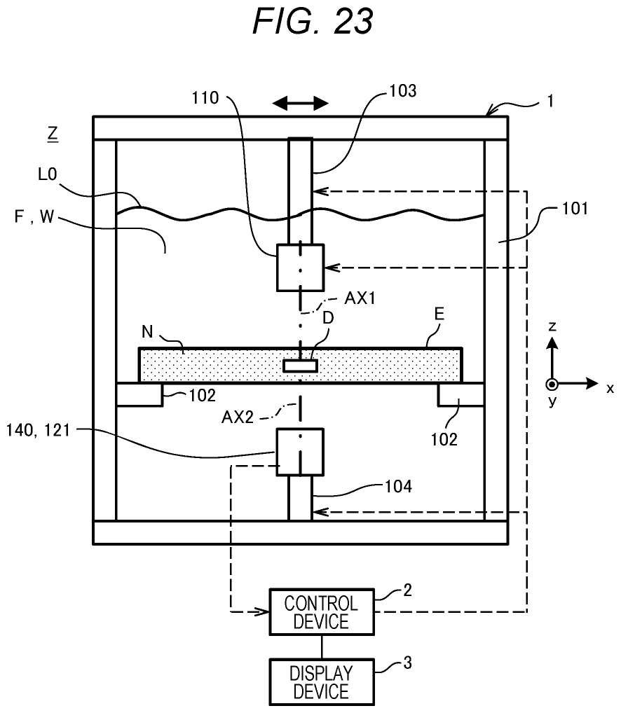

FIG. 23 depicts a configuration of an ultrasonic inspection apparatus Z according to a fourth embodiment. In the fourth embodiment, the fluid F is the liquid W, which is water in FIG. 23. The ultrasonic inspection apparatus Z inspects the inspection subject E by emitting the ultrasonic beam U onto the inspection subject E through the liquid W, which is the fluid F. The inspection subject E is disposed below a liquid level L0 of the liquid W, that is, immersed in the liquid W.

It should be noted that the fluid F may be the gas G (FIG. 1), as in the above embodiments, or may be the liquid W (FIG. 23), as in this embodiment. When the gas G, such as air, is used as the fluid F, a more preferable effect is achieved for the following reasons.

An amount of attenuation of the ultrasonic wave is greater in the gas G than in the liquid W. It is known that the amount of attenuation of the ultrasonic wave in the gas G is proportional to the square of the frequency. For this reason, about 1 MHz is specified as an upper limit frequency in a case where the ultrasonic wave is propagated in the gas G. Given the fact that the liquid W allows an ultrasonic wave of 5 MHz to several 10 MHz to propagate therein, it is concluded that a working frequency in the gas G is lower than that in the liquid W.

Generally, the lower frequency of the ultrasonic beam U makes convergence of the ultrasonic beam U difficult. For this reason, the ultrasonic beam U of 1 MHz propagating in the gas G has a convergence-allowing beam diameter larger than that of the ultrasonic beam U in the liquid W. In the blocking mode shown in FIG. 4, which is the conventional method, detecting the defect part D of a size smaller than the beam size is difficult. However, according to the present disclosure, the ratio of scattered wave components is increased in detection, as indicated in FIG. 5, and this allows detection of the defect part D of the size smaller than the beam size.

When the gas G is used as the fluid F, reducing the beam size of the ultrasonic beam U becomes more difficult. In this case, therefore, an effect the present disclosure offers is greater. In this manner, the present disclosure offers a more preferable effect when the gas G is used as the fluid F.

### Fifth Embodiment

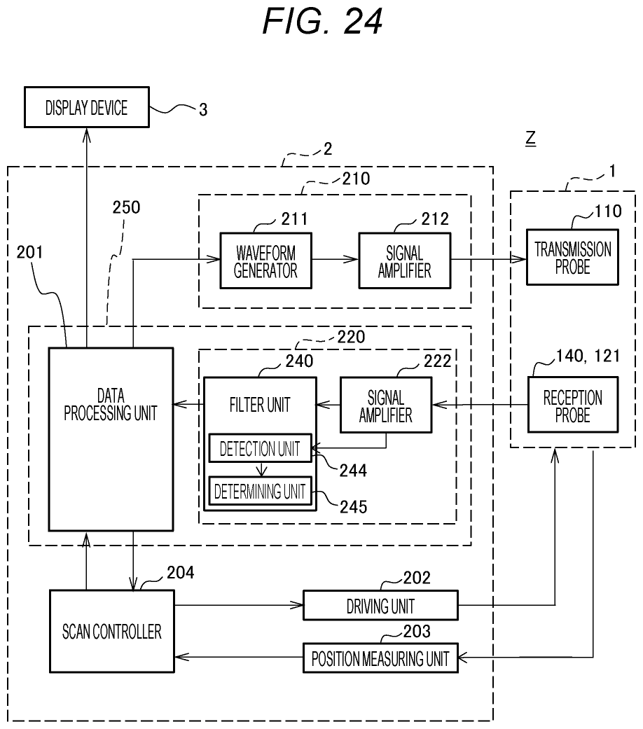

FIG. 24 is a functional block diagram of the control device 2 in an ultrasonic inspection apparatus Z according to a fifth embodiment. In the fifth embodiment, a filter used in the filter unit 240 is determined by emitting the ultrasonic beam U onto a sample (not illustrated) with the position of the defect part D already known before inspection of the inspection subject E. Inspection of the inspection subject E is then conducted using the filter determined before the inspection.

The filter unit 240 includes a detection unit 244 and a determination unit 245. The detection unit 244 detects a plurality of different skirt components W3 in the fundamental waveband W1 in a relationship between the frequency and the signal intensity (component intensity). The relationship mentioned here is, for example, the relationship shown in FIG. 11, and is obtained by emitting the ultrasonic beam U onto the sound part N and the defect part D of the sample (not illustrated) with the position of the defect part D already known. The determination unit 245 determines which skirt component W3 is to be used by comparing the plurality of skirt components W3 detected. By configuring the filter unit 240 in this manner, the skirt component W3 that facilitates identification of a signal change caused by the defect part D can be used and therefore the accuracy of detection of the defect part D can be improved.

The detection unit 244 has, for example, filters capable of detecting different skirt components W3. These filters are, for example, at least two of the above-mentioned band elimination filter (FIG. 12A), low-pass filter (FIG. 12B), and high-pass filter (FIG. 12C). For example, when the detection unit 244 has these three filters, the detection unit 244 detects the skirt component W3 shown in FIG. 12B, the skirt component W3 shown in FIG. 13B, and the skirt component W3 shown in FIG. 14B in the relationship shown in FIG. 11, using the three filters. Then, the determination unit 245 compares the three skirt components W3 detected and determines which skirt component W3 is to be used, for example, by selecting a skirt component W3 that maximizes the difference between the sound part N and the defect part D. The filter unit 240 inspects the inspection subject E using the determined skirt component W3. This improves the accuracy of detection of the defect part D.

### Sixth Embodiment

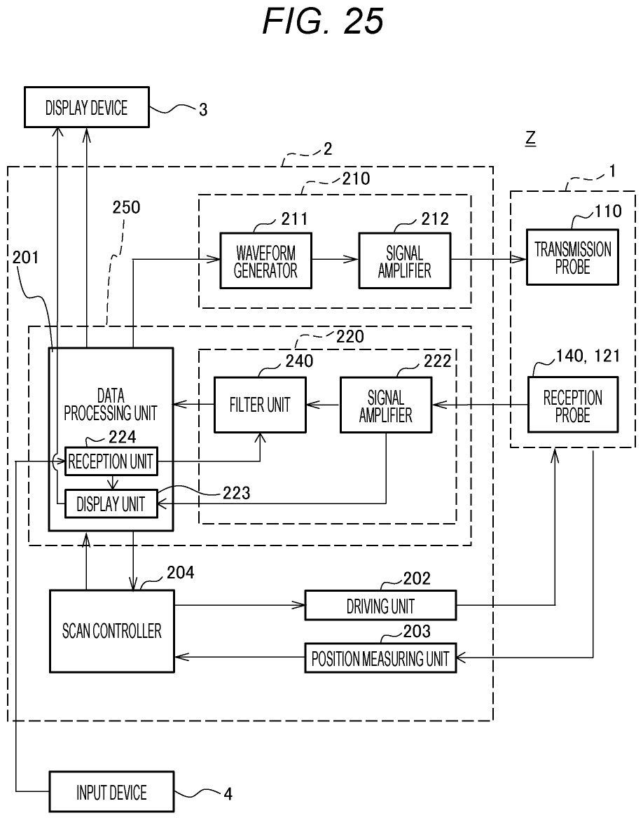

FIG. 25 is a functional block diagram of the control device 2 in an ultrasonic inspection apparatus Z according to a sixth embodiment. In the sixth embodiment, before inspection of the inspection subject E, data obtained by emitting the ultrasonic beam U onto a sample (not illustrated) with the position of the defect part D already known is presented to a user, and the user determines which skirt component W3 is to be used, that is, which filter is to be used.

The control device 2 includes a display unit 223 and a reception unit 224. The display unit 223 and the reception unit 224 are included in the data processing unit 201 in the example of FIG. 25. The display unit 223 causes the display device 3 to display a relationship between the frequency and the signal intensity (component intensity). The relationship mentioned here is, for example, the relationship shown in FIG. 11, and is obtained by emitting the ultrasonic beam U onto the sound part N and the defect part D of the sample (not illustrated) with the position of the defect part D already known. The reception unit 224 receives information indicating the skirt component W3 to be detected, the information being inputted by the user, based on the relationship between the frequency and the signal strength. The information is inputted on an input device 4, such as a keyboard, a mouse, or a touch panel. Based on the information received by the reception unit 224, the filter unit 240 detects the skirt component W3 indicated by the information.

By configuring the control device 2 in this manner, the user is able to determine the skirt component W3 to be detected, based on the user's subjective judgement. The user is thus able to make a judgement based on the user's experience, and is therefore able to execute an inspection reflecting the actual condition of the inspection subject.

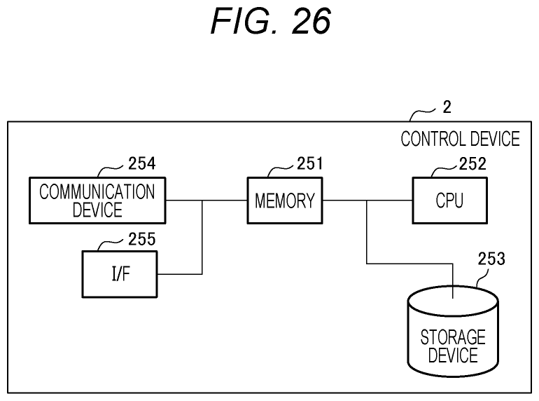

FIG. 26 depicts a hardware configuration of the control device 2. Some or all of the above-described constituent elements, functions, and units making up block diagrams may be provided in the form of hardware by, for example, packaging them in integrated circuits. As indicated in FIG. 26, the above constituent elements, functions, and the like may be provided in the form of software by a processor, such as a CPU 252, interpreting and executing programs for implementing individual functions. The control device 2 includes, for example, a memory 251, the CPU 252, a storage device 253 (SSD, HDD, etc.), a communication device 254, and an I/F 255. Information for implementing the functions, such as programs, tables, and files, are stored in an HDD and may also be stored in a recording device, such as a memory or a solid state drive (SSD), or in a recording medium, such as an integrated circuit (IC) card, a secure digital (SD) card, or a digital versatile disc (DVD).

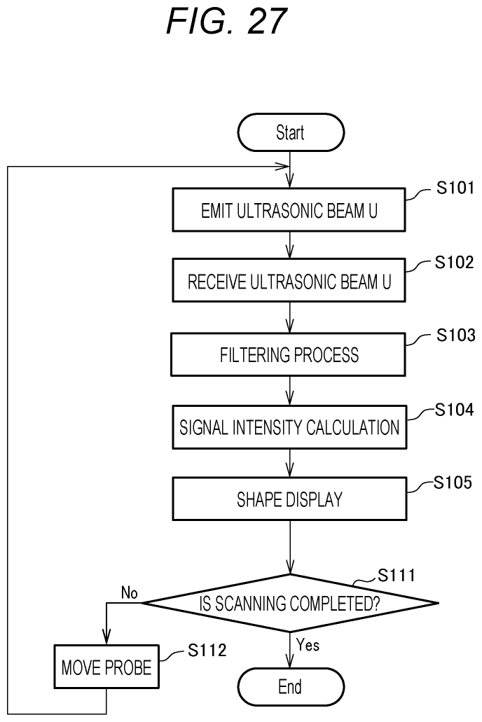

FIG. 27 is a flowchart showing an ultrasonic inspection method of each of the above embodiments. An ultrasonic inspection method of the first embodiment can be executed by the above-described ultrasonic inspection apparatus Z, and will be described as an example, referring to FIGS. 1 and 6 on a necessary basis. The ultrasonic inspection method of the first embodiment is the method according to which the inspection subject E is inspected by emitting the ultrasonic beam U onto the inspection subject E (FIG. 1) via the gas G (an example of the fluid F shown in FIG. 1). An embodiment of the ultrasonic inspection method using the gas G as the fluid F will be described. It is obvious, however, that this ultrasonic inspection method is also effective for an embodiment in which the liquid W (FIG. 23) is used as the fluid F.

First, following an instruction from the control device 2, the transmission probe 110 executes an emission step S101 of emitting the ultrasonic beam U from the transmission probe 110. Subsequently, the reception probe 121 executes a reception step S102 of receiving the ultrasonic beam U.

Thereafter, based on a signal of the ultrasonic beam U (e.g., a waveform signal) received by the reception probe 121, the filter unit 240 executes a filtering step S103 of reducing a component (maximum intensity frequency component) in a specific frequency range, specifically, a frequency range including the maximum component frequency fm. Then, the data processing unit 201 executes a signal intensity calculation step S104 of detecting the skirt component W3 of the fundamental waveband W1 from the signal subjected to the filtering and generating signal intensity data. As a method of generating the signal intensity data, according to this embodiment, a peak-to-peak signal volume is used. The peak-to-peak signal volume represents the difference between the maximum value and the minimum of the signal.

Subsequently, a shape display step S105 is executed. Scanning position information on the transmission probe 110 and the reception probe 121 is transmitted from the position measurement unit 203 to the scan controller 204. The data processing unit 201 plots signal intensity data obtained at each scanning position against scanning position information on the transmission probe 110, the scanning position information being acquired from the scan controller 204. Hence the signal intensity data is put into an image. This is the shape display step S105.

It should be noted that FIG. 8B shows a case where the scanning position information is one-dimensional (one direction) information and that in a case where the scanning position information is two-dimensional information including the x and y plane, plotting the signal intensity data puts the defect part D into a two-dimensional image, which is displayed on the display device 3.

The data processing unit 201 determines whether scanning is completed (step S111). When scanning is completed (Yes), the control device 2 ends its process. When the scanning is not completed (No), the data processing unit 201 outputs an instruction to the driving unit 202, thereby moving the transmission probe 110 and the reception probe 121 to the next scanning position (step S112), and then returns to the emission step S101.

According to the ultrasonic inspection apparatus Z and the ultrasonic inspection method that are described above, the capability to detect the defect part D, for example, the capability to detect a minute defect can be improved.

Each of the above embodiments is the description of an example in which the defect part D is a cavity. The defect part D, however, may be a foreign object containing a material different from the material of the inspection subject E. In this case, as in the above cases, an acoustic impedance difference (Gap) arises at an interface where different materials are in contact with each other, and the scattered wave U1 is generated as a consequence. For this case, the configuration of each of the above embodiments works effectively. It is a general assumption that the ultrasonic inspection apparatus Z is used as an ultrasonic defect imaging apparatus. However, it may also be used as a non-contact in-line internal defect inspection apparatus.

The present disclosure is not limited to the above embodiments but includes various modifications. For example, the above embodiments have been described in detail for easy understanding of the present disclosure, and are not necessarily limited to an embodiment including all constituent elements described above. Some constituent elements of a certain embodiment may be replaced with constituent elements of another embodiment, and a constituent element of another embodiment may be added to a constituent element of a certain embodiment. In addition, some of constituent elements of each embodiment may be deleted therefrom or add to or replaced with constituent elements of another embodiment.

In the above embodiment, a group of control lines/data lines considered to be necessary for description are illustrated, and all control lines/data lines making up the product are not always illustrated. It is safe to assume that, actually, almost the entire constituent elements are interconnected.

### REFERENCE SIGNS LIST

1 scanning/measuring device
101 enclosure
102 sample stage
103 transmission probe scanning unit
104 reception probe scanning unit
105 eccentric distance adjustment unit
106 set angle adjustment unit
110 transmission probe
111 transducer
112 backing
113 matching layer
114 probe surface
115 transmission probe enclosure
116 connector
117 lead wire
118 lead wire
120 reception probe
121 reception probe
140 reception probe
2 control device
201 data processing unit
202 driving unit
203 position measurement unit
204 scan controller
210 transmission system
211 waveform generator
212 signal amplifier
220 reception system
222 signal amplifier
223 display unit
224 reception unit
231 signal intensity calculation unit
240 filter unit
241 frequency component conversion unit
242 frequency selection unit
243 frequency component reverse conversion unit
244 detection unit
245 determination unit
250 signal processing unit
251 memory
252 CPU
253 storage device
254 communication device
255 VF
3 display device
4 input device
AX1 transmission sound axis
AX2 reception sound axis
BW beam width
C1 intersection point
C2 intersection point
C3 cone
D defect part
E inspection subject
F fluid
G gas
G0 gain
G1 gain
L eccentric distance
L0 liquid level
N sound part
P1 focal point
P2 focal point
R1 focal distance
R2 focal distance
S101 emission step
S102 reception step
S103 filtering step
S104 signal intensity calculation step
S105 shape display step
S111 step
S112 step
T0 fundamental period
T1 beam incident area
T2 beam incident area
U ultrasonic beam
U1 scattered wave
U2 ultrasonic beam
U3 direct wave
W liquid
W1 fundamental waveband
W2 frequency range
W3 skirt component
Z ultrasonic inspection apparatus
α angle
α2 angle
β refraction angle
β2 angle
Δv variation
θ angle

1. An ultrasonic inspection apparatus that inspects an inspection subject by emitting an ultrasonic beam onto the inspection subject via a fluid, the ultrasonic inspection apparatus comprising:
a scanning/measuring device that carries out scanning and measurement on the inspection subject, using the ultrasonic beam; and
a control device that controls driving of the scanning/measuring device, wherein
the scanning/measuring device includes a transmission probe that emits the ultrasonic beam; and
a reception probe that receives the ultrasonic beam, wherein
the control device includes a signal processing unit, wherein
the signal processing unit includes a filter unit that reduces at least a maximum intensity frequency component of a reception signal received by the reception probe, and wherein
the filter unit detects a skirt component in a fundamental waveband including the maximum intensity frequency component, the skirt component being a part of the fundamental waveband that is other than the maximum intensity frequency component.

2. The ultrasonic inspection apparatus according to claim 1, wherein a focal distance of the reception probe is longer than a focal distance of the transmission probe.

3. The ultrasonic inspection apparatus according to claim 1, wherein a beam incident area of the reception probe is larger than a beam incident area of the transmission probe.

4. The ultrasonic inspection apparatus according to claim 1, wherein the fluid is a gas.

5. The ultrasonic inspection apparatus according to claim 1, wherein the filter unit includes a band elimination filter.

6. The ultrasonic inspection apparatus according to claim 1, wherein the filter unit includes a low-pass filter.

7. The ultrasonic inspection apparatus according to claim 1, wherein the filter unit includes a high-pass filter.

8. The ultrasonic inspection apparatus according to claim 1, wherein
the filter unit includes:
a frequency component conversion unit that converts a reception signal of the reception probe into a frequency component; and
a frequency selection unit that selects the skirt component by removing a frequency band including the maximum intensity frequency component.

9. The ultrasonic inspection apparatus according to claim 1, wherein
the filter unit includes:
a detection unit that detects a plurality of different skirt components in the fundamental waveband in a relationship between frequency and signal intensity, the relationship being obtained by emitting the ultrasonic beam onto a sound part and a defect part of a sample with a position of the defect part already known; and
a determination unit that determines which the skirt component is to be used by comparing the plurality of skirt components detected.

10. The ultrasonic inspection apparatus according to claim 1, wherein
the control device includes:
a display unit that causes a display device to display a relationship between frequency and signal intensity, the relationship being obtained by emitting the ultrasonic beam onto a sound part and a defect part of a sample with a position of the defect part already known; and
a reception unit that receives information indicating the skirt component to be detected, the information being inputted by a user, based on the relationship, and wherein
the filter unit detects the skirt component, based on the information received by the reception unit.

11. The ultrasonic inspection apparatus according to claim 1, wherein a distance between a sound axis of the transmission probe and a sound axis of the reception probe is larger than zero.

12. The ultrasonic inspection apparatus according to claim 1, wherein a distance between a sound axis of the transmission probe and a sound axis of the reception probe is zero.

13. An ultrasonic inspection method of inspecting an inspection subject by emitting an ultrasonic beam onto the inspection subject via a fluid, the method comprising:
an emission step of emitting an ultrasonic beam from a transmission probe;
a reception step of receiving the ultrasonic beam;
a filtering step of reducing a maximum intensity frequency component of a signal of the ultrasonic beam received at the reception step; and
a signal intensity calculation step of detecting a skirt component of a fundamental waveband of the signal of the ultrasonic beam.

14. The ultrasonic inspection method according to claim 13, wherein the fluid is a gas.
